(19) United States
(12) Patent Application Publication
(10) Pub. No.: US 2007/0031086 A1
(43) Pub. Date: Feb. 8, 2007

(54) Optical multiplexer / de-multiplexer with regions of altered refractive index

(76) Inventors: Kenneth R. Wildnauer, Santa Rosa, CA (US); William R. Trutna JR., Palo Alto, CA (US)

Correspondence Address: AVAGO TECHNOLOGIES, LTD.;c/o Klaas, Law, O'Meara & Malkin, P.C., P. O. Box 1920, Denver, CO, 80201-1920, US

(21) Appl. No.: 11/545,681

(22) Filed: Oct. 10, 2006

Related U.S. Application Data
(62) Division of application No. 10/347,069, filed on Jan. 17, 2003.

(51) Int. Cl. G02B 6/26; G02B 6/42

(52) U.S. Cl. 385/47; 385/15; 385/31; 385/37; 385/39; 385/50; 385/16; 385/18

(57) ABSTRACT

A method of making an optical device to wavelength multiplex/de-multiplex light signals by altering the refractive index of regions within a material is disclosed. A substrate is formed from a material having a refractive index that can be altered by a process. At least one region within the substrate is subjected to the process, thereby altering the refractive index of the substrate within that region. An optical component of the multiplexer/de-multiplexer is formed by or includes the altered region. Also disclosed is an optical multiplexer/de-multiplexer device that includes an optical component that includes a region within a substrate, in which the region has an altered refractive index.

### BACKGROUND

Modern research and technology have created major changes in the lives of many people. A significant example of this is fiber optic communication. Over approximately the last two decades, fiber optic lines have taken over and transformed the long distance telephone industry. Optical fibers also play a dominant role in making the Internet available around the world. When optical fiber replaces copper wire for long distance calls and Internet traffic, costs are dramatically lowered and the rate at which information can be conveyed is increased.

Optical fibers convey voice, Internet traffic and other information digitally at rates that currently range upward from one gigabit per second, and that are expected to reach hundreds of gigabits per second. In order to achieve these rates, a light emitting device sends out a beam of light that is turned on and off at the data rate, that is, at upward of one billion times each second. On the other end of the fiber optic cable, another device receives that beam of light and detects the pattern with which the light signal is turned on and off.

To maximize bandwidth, that is, the rate at which data can be transmitted, it is generally preferable for multiple light signals to be conveyed over the optical fiber at different wavelengths, that is, using different wavelengths of light. For example, the conventional or “C” band as established by the International Telecommunication Union (ITU) supports optical communication signals that range in wavelength between about 1525 nanometers and about 1560 nanometers. A description of the ITU standards may be found at www.itu.int, for example. The range of the “C” band can convey up to about 20 different or independent signals that are separated in wavelength by an increment of about 1.6 nanometers. However, the “C” band can convey many more signals if smaller wavelength increments can be supported.

An optical multiplexer is an optical device that receives two or more light signals at different wavelengths and combines these into a single light signal that includes multiple wavelengths. An optical de-multiplexer performs the converse function on the receiving end. That is, an optical de-multiplexer receives a single, multi-wavelength light signal and separates this signal into its constituent single-wavelength light signals.

One problem and challenge is that optical multiplexers and de-multiplexers must be very precisely designed and manufactured. It is desirable for these devices to combine and separate many single-wavelength light signals having only small wavelength increments between adjacent signals. Such dense packing of single-wavelength light signals enables the optical communication system to convey a large amount of information over a single optical fiber; however, such dense packing requires very precise manufacture and alignment of every optical component within the device.

Other problems in the design and manufacture of optical multiplexers and de-multiplexers arise from the requirement that they be produced in high volume. Hundreds of thousands of multiplexers and de-multiplexers are in use today in optical communication systems. Production rates in excess of tens of thousands of units per month are projected.

Optical multiplexers, de-multiplexers or both may also be used in optical communication systems wherever different light signals are to be added to or removed from an optical fiber. These devices may also be used wherever the wavelength of a light signal is to be changed.

Further, light signals typically deteriorate, that is they weaken, become distorted, or both after the signals are conveyed a certain distance even over a high quality optical fiber. One of the ways to compensate for this deterioration is for the light signals to be converted into electronic signals, electronically amplified and perhaps equalized or otherwise adjusted, and then re-emitted as light signals. When wavelength division multiplexing is employed, each such conversion and re-emission stage requires one or more optical multiplexers and one or more optical de-multiplexers.

### SUMMARY OF THE INVENTION

Thus, there is a need for a high volume, high precision method of making optical multiplexers and de-multiplexers. Some embodiments of the invention meet both the volume and the precision needs by forming an optical component within a substrate by altering the refractive index within patterned regions of the substrate. In other embodiments, multiple optical components are formed in alignment with each other within a substrate.

The invention provides an optical multiplexer/de-multiplexer, that is, an optical device that can be used to multiplex multiple single-channel light signals into a multi-channel light signal, to de-multiplex a multi-channel light signal into its constituent single-channel light signals, or to perform both multiplexing and de-multiplexing. One or more optical components of the device include one or more regions within the substrate that have an altered refractive index.

The invention also provides a method of making optical multiplexers/de-multiplexers. In some embodiments of the invention, a substrate is formed from a material having a refractive index that can be altered by a process. One or more regions within the substrate are subjected to the process, which alters the refractive index of the substrate within such regions. One or more optical components of the optical multiplexer/de-multiplexer are formed by the altered regions.

The process used to alter the refractive index of regions within the substrate may include: exposing the regions to an electron beam; exposing the regions to electromagnetic radiation; exposing the regions to light; exposing the regions to a laser beam; exposing the regions to a light wave interference pattern; exposing the region to X-rays; exposing the region to a collimated X-ray beam; subjecting the regions to a chemical process; subjecting the regions to heat; subjecting the regions to pressure; other processes; or combinations thereof.

The optical components that include a region with an altered refractive index may include: a diffraction grating; a planar diffraction grating; a concave diffraction grating; an aberration-correcting diffraction grating; an optical component for a multi-channel optical path; an optical component for a single-channel optical path; an

optical coupler; an optical guide; an optical aperture, or another optical component within the multiplexer/de-multiplexer.

### BRIEF DESCRIPTION OF THE DRAWING

The drawing illustrates technologies related to the invention, shows example embodiments of the invention, and gives examples of using the invention. The objects, features, and advantages of the invention will become more apparent to those skilled in the art from the following detailed description, when read in conjunction with the accompanying drawing, wherein:

FIG. 1 shows a functional diagram of a first example optical multiplexer/de-multiplexer according to the invention, in which optical imaging components, optical apertures and a transmission diffraction grating include regions within a substrate that have an altered refractive index;

FIG. 2 shows a functional diagram of a second example optical multiplexer/de-multiplexer according to the invention, in which optical apertures and a reflective diffraction grating include regions within a substrate that have an altered refractive index;

FIG. 3A shows a functional diagram of a third example optical multiplexer/de-multiplexer according to the invention, in which a diffraction grating includes a grooved surface of the substrate and optical guides include regions within a substrate that have an altered refractive index;

FIG. 3B shows a functional diagram of a fourth example optical multiplexer/de-multiplexer according to the invention, which has a diffraction grating similar to the previous figure, optical guides similar to the previous figure, and angled protrusions through which the optical guides pass;

FIGS. 4A and 4B respectively show a top view and a side view that illustrate a process, according to an embodiment of the invention, of altering the refractive index within regions of a substrate by exposing the regions to laser light;

FIG. 5A shows a side view that illustrates altering, according to an embodiment of the invention, the refractive index within regions of a substrate by using holographic techniques to expose the substrate to an interference pattern;

FIG. 5B shows a side view that illustrates fabricating, according to an embodiment of the invention, a substrate by assembling a two piece substrate; and

FIG. 6 shows a cross-sectional side view that illustrates shaping, according to an embodiment of the invention, a substrate to form a diffraction grating by using an injection mold.

### DETAILED DESCRIPTION OF THE PREFERRED EMBODIMENTS

The descriptions and discussions herein illustrate technologies related to the invention, show examples of the invention and give examples of using the invention. Known methods, procedures, systems, circuits or components may be discussed without giving details, to avoid obscuring the principles of the invention. On the other hand, numerous details of specific examples of the invention may be described, even though such details may not apply to other embodiments of the invention. Details are included and omitted to better explain the invention and to aid in understanding the invention.

The invention is not to be understood as being limited to or defined by what is discussed herein. The invention may be practiced without the specific details described herein. One skilled in the art will realize that numerous modifications, variations, selections among alternatives, changes in form, and improvements can be made without departing from the principles, intention, or legal scope of the invention.

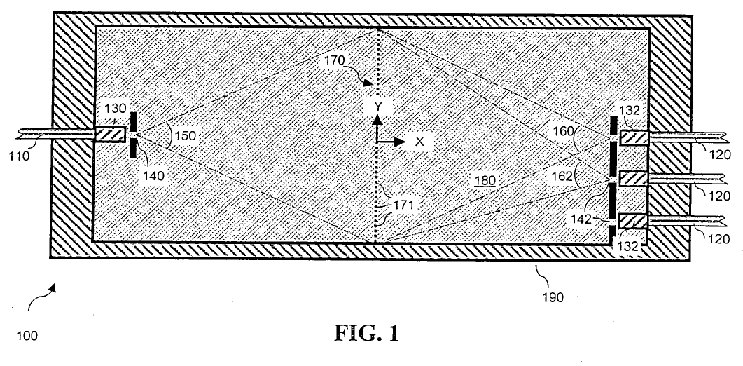

FIG. 1 is a functional diagram of an example optical multiplexer/de-multiplexer according to an embodiment of the invention. FIG. 1 is not drawn to scale. Nevertheless, the center of diffraction grating 170 may be taken to define the origin of a standard, right-hand, three-dimensional coordinate system. In this system, the X and Y coordinates increase in the directions shown by the corresponding axes and Z coordinates increase towards the viewer. The X-Y plane is the plane of FIG. 1 and is also the diffraction plane.

In optical multiplexer/de-multiplexer 100, substrate 180, or at least a portion of substrate 180, is formed from a material that has a refractive index that can be altered. Selected regions within substrate 180 have been subjected to a process that causes such alteration; thus, the refractive index of the substrate within those regions differs from the base refractive index of the substrate. Several optical components of device 100 include one or more altered regions, specifically, optical imaging components 130 and 132, optical apertures 140 and 142, and diffraction grating 170.

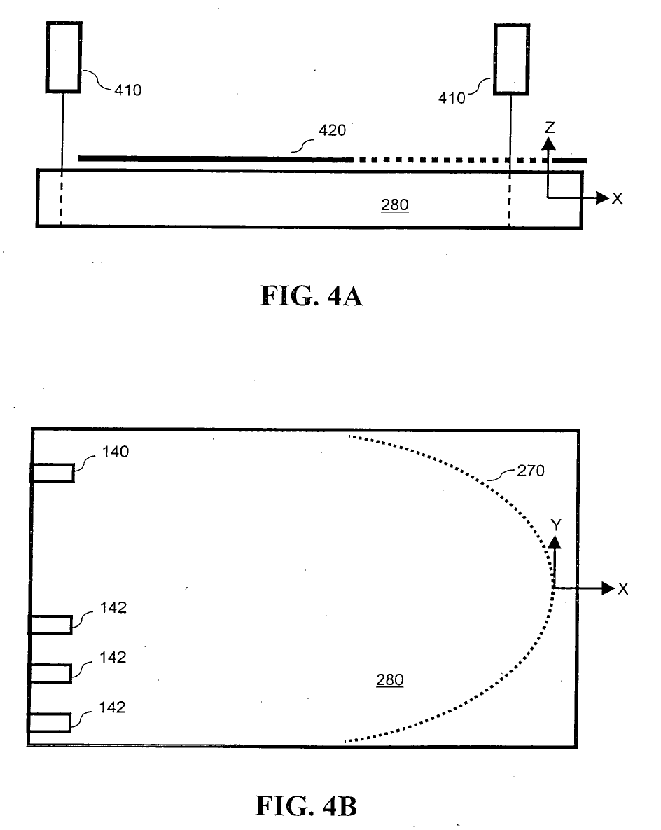

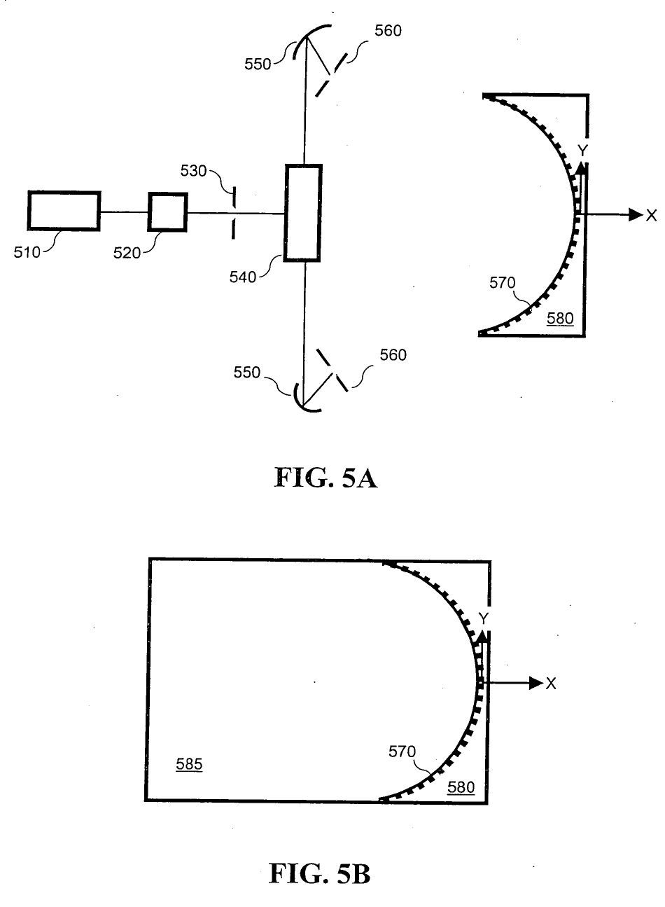

In some embodiments of the invention, the substrate comprises hydrogen loaded glass. Hydrogen loaded glass is photosensitive; specifically, exposure to ultra-violet light alters the refractive index of the exposed glass at the infrared wavelengths used in optical communication systems. The exposure process used may include, but is not limited to, exposing the regions to light in a process similar to that shown in FIGS. 4A and 4B, or exposing the regions to a light wave interference pattern in a process similar to that shown in FIG. 5A. In other embodiments, the refractive index of regions within other materials may be altered by subjecting the regions to localized heat, pressure or both; localized chemical doping; or localized ion implantation.

Housing 190 secures external optical path 110 to one side of substrate 180. Housing 190 also holds path 110 in alignment with substrate 180, and thus in alignment with the optical components contained within substrate 180. Housing 190 also secures and aligns a number of external optical paths 120 to substrate 180 on the side of substrate 180 that is opposite to external path 110. Housing 190 may be any material, device or assembly that secures, protects or holds together the various components of optical multiplexer/de-multiplexer 100.

Each of external optical paths 110 or 120 ends adjacent to a corresponding one of optical imaging components 130 or 132, respectively. Each of external optical paths 110 or 120 couples a light signal to or from this corresponding optical imaging component. Only portions of external optical paths 110 and 120 are shown in FIG. 1.

Each optical imaging component 130 or 132 is adjacent to, and couples a light signal to or from, a corresponding one of optical apertures 140 or 142. Multi-channel light signal 150 travels in either or both directions between optical aperture 140 and diffraction grating 170. Each single channel light signals, such as 160 or 162, travels in either or both directions between diffraction grating 170 and a corresponding one of optical apertures 142.

For clarity, FIG. 1 shows only two single-channel light signals, i.e. 160 and 162. In FIG. 1, the lines that denote light beams 150, 160 and 162 are merely general indications of the region of device 100 in which these light signals travel. These lines are not indented to represent contours of equal illumination intensity, the maximum extent of the light signals or the properties of the optical imaging devices used.

Each single-channel light signal passes through a corresponding single-channel optical path. Each single-channel optical path comprises one external optical path 120, one optical imaging component 132 and one optical aperture 142. For clarity, FIG. 1 shows only three single-channel optical paths. Multi-channel light signal 150 passes through a multi-channel optical path, which comprises external optical path 110, optical imaging component 130 and optical aperture 140.

The angle at which light leaves diffraction grating 170 depends both on the angle of incidence of the light on grating 170 and on the wavelength of the light. Thus, the Y coordinate of each optical aperture 142 depends on, among other factors, the wavelength of the particular single-channel light signal that corresponds to that particular aperture. The diffraction plane of grating 170 contains a single-channel point that corresponds to the wavelength of single-channel light signal 160. This single-channel point is located at the center of the instance of aperture 142 that has the highest Y coordinate. Similarly, single-channel light signal 162 has a wavelength that corresponds a different single-channel point, which is located at the center of the next highest aperture 142. The multi-channel point of the diffraction plane is at the center of aperture 140.

Because diffraction grating 170 is a transmission grating through which light passes, the single-channel and the multi-channel optical components are on opposite sides of diffraction grating 170. As shown in FIG. 1, the multi-channel optical components are positioned in the negative X half of the X-Y plane and are centered around the X axis. The single-channel optical components are positioned in the positive X half of the X-Y plane and are offset from and asymmetric with respect to the Y axis.

In various embodiments of the invention, it may be desirable to position these optical components at different points within the diffraction plane. For example, the multi-channel point of the diffraction plane need not lie on the X axis, and thus the multi-channel optical components need not be centered on the X axis. Any or all of the single-channel optical components or the multi-channel optical components could be positioned differently in the X direction, the Y direction, or both. Optimal positions may depend factors that include, among others: the set of wavelengths being used for the light signals; the shape of the diffraction grating used; the size, shape and pitch between the altered regions that make up the diffraction grating; whether the diffraction grating is designed to correct aberration; and whether a light signal with a wave front curvature that is spherical, planar or has another shape would properly match the design of the diffraction grating.

When used for de-multiplexing, optical multiplexer/de-multiplexer 100 functions to separate one multi-channel light signal into multiple single-channel light signals having different wavelengths. Multi-channel light signal 150 enters device 100 on multi-channel external optical path 110. Optical imaging component 130 projects an image of signal 150 from the end of external optical path 110 onto a substantial portion of the two-dimensional surface of diffraction grating 170. This image is spatially filtered by aperture 140, which is centered on the multi-channel point of the diffraction plane. Diffraction grating 170 diffracts multi-channel light signal 150 to form at least two single-channel light signals, such as signals 160 and 162. Each single-channel light signal is spatially filtered by a corresponding one of optical apertures 142, each positioned at a corresponding single-channel point of the diffraction plane. Each imaging component 132 projects an image of a particular single channel light signal from a corresponding aperture 142 onto the end of a corresponding single-channel external optical path 120. Each single-channel light signal leaves device 100 on a corresponding external optical path 120.

When used for multiplexing, optical multiplexer/de-multiplexer 100 functions to combine multiple single-channel light signals of different wavelengths into one multi-channel light signal 150. Each single-channel light signal, such as 160 and 162, enters device 100 on a corresponding single-channel external optical path 120. The single-channel light signals are spatially filtered by optical apertures 142, each of which is positioned at the particular single-channel point of the diffraction plane that corresponds to the wavelength of the corresponding single-channel light signal. Each optical imaging device 132 projects one of the single-channel light signals onto a substantial portion of the two-dimensional surface of diffraction grating 170. Diffraction grating 170 diffracts the single-channel light signals such that these signals spatially overlap at the multi-channel point of the diffraction plane, that is, at the center of aperture 140. The diffraction thus forms multi-channel light signal 150. Multi-channel light signal 150 is spatially filtered by optical aperture 140. Optical imaging device 130 images multi-channel light signal 150 onto the end of multi-channel external optical path 110. Multi-channel light signal 150 leaves device 100 on external optical path 110.

The optical paths used, such as 110 and 120, may be optical fibers, waveguides, lens assemblies, optical paths in free space or any device or material that is capable of conveying a light signal. Often the multi-channel optical paths are optical fibers that extend over a substantial distance, possibly 80 to 100 kilometers.

Optical imaging components 130 and 132 include one or more regions within substrate 180 that have a refractive index that is altered by subjecting the regions to a process. In various embodiments of the invention, the optical imaging components used, such as 130 and 132, may be any optical components that can image the light signals used in the optical multiplexer/de-multiplexer. Some embodiments of the invention advantageously employ optical imaging components based on graded index (GRIN) lenses, in which the optical properties of the lens are determined not by its shape, but by the gradation in refractive index within the lens. In some GRIN lenses, the refractive index of the lens is at a maximum value along the center of the lens, and the index may decrease as the distance from the center increases.

In some of these embodiments that use a type of a GRIN lens known as a pitch controlled GRIN lens, the length of the lens is designed to be a particular ratio, including but not limited to 25%, of the pitch of the light as it travels through the lens. Light in a GRIN lens tends to travel a path that is approximately sinusoidal from being focused at the center of the lens, to being maximally dispersed toward the edges of the GRIN lens, and then to being centrally focused again. The length of one cycle of this dispersion and focusing process is known as the pitch of the lens. A quarter or 25% pitch GRIN lens may be used to collimate a light beam, a pitch of somewhat less than 25% may be used to disperse a light beam, and a pitch of somewhat more than 25% may be used to focus a light beam.

In various other embodiments of the invention, the devices used for the optical imaging components may include, but are not limited to: a single discrete lens; an assembly of multiple lens; an aspheric lens; or combinations thereof.

In various embodiments of the invention, the imaging functions of the components used, such as optical imaging components 130 and 132, may vary depending on the design of the embodiment and on whether the light signal is being conveyed to the diffraction grating or to an external optical path. These imaging functions may include: collimating; dispersing; focusing; correcting for refraction at the boundary between the optical path and the substrate; altering the wave front curvature of the light signals; guiding the light signals to or from the external optical paths; other functions; or combinations thereof.

Each of optical apertures 140 and 142 also include one or more altered regions, as discussed above. The optical apertures used in some embodiments of the invention, such as apertures 140 and 142 are narrow slits that are disposed along straight lines parallel to the Z axis. Alternatively, the apertures used may be components that have the optical effect of such slits. In other embodiments, the apertures used may be curved slits, or have the optical effect of curved slits. Such curved apertures include, but are not limited to apertures disposed along hyperbolic sections that lie in a plane parallel to the Z axis. In some embodiments of the invention, such curved apertures are used to help correct for aberration.

In order to combine or separate the single-channel light signals without distortion, such as cross talk among the various light signals, a spatial filtering function is generally desirable. Nevertheless, the imaging components used, the optical paths used, or other optical components used within the single-channel optical path or the multi-channel optical paths may perform sufficient spatial filtering. Thus, optical apertures are optional and may be omitted in some embodiments of the invention.

Diffraction grating 170 is a planar transmission grating that comprises many discrete regions 171 of altered refractive index within substrate 180. In the aggregate, regions 171 constitute a planar surface disposed along the Y axis. Each region 171 is centered on a straight line running parallel to the Z axis. Each region 171 may be called a diffraction line; however on a small scale, each diffraction “line” is actually a cylinder with a volume and a cross section in the X-Y plane. In various embodiments of the invention, this cross section may be circular, rectangular, triangular, or may have another shape.

The de-multiplexing function of the diffraction grating is to angularly separate light of various wavelengths from a single multi-channel light signal to form single-channel light signals. The multi-channel light signal is emitted toward the diffraction grating from a multi-channel point of the diffraction grating. In device 100, the multi-channel point is at the center of optical aperture 140. The diffraction grating diffracts the multi-channel light signal to form a number of single-channel light signals, each of which is formed at the particular single-channel point of the diffraction grating that corresponds to the particular wavelength of that single-channel light signal. In device 100, each single-channel point is at the center of a corresponding optical aperture 142. In other embodiments of the invention, optical components other than apertures may be located at the multi-channel point, at the single-channel points, or both.

The multiplexing function of the diffraction grating is to combine multiple single-channel light signals having different wavelengths to form a single multi-channel light signal. Each single-channel light signal is emitted toward the diffraction grating from the single-channel point that corresponds to the wavelength of that single-channel signal. The diffraction grating diffracts the single-channel light signals such that these signals spatially overlap at the multi-channel point.

All diffraction lines within diffraction grating 170 are straight cylinders of uniform size and spacing. However, other embodiments of the invention use a grating with curved diffraction lines or with diffraction lines that are non-uniform in size, shape or spacing. Such diffraction gratings may be advantageous in correcting aberration or for other purposes.

Diffraction grating 170 is a planar diffraction grating, wherein the diffraction lines are centered on the Y-Z plane. One or more imaging components, such as imaging components 130 and 132 are generally used in conjunction with a planar diffraction grating.

Other embodiments of the invention advantageously employ a diffraction grating that is curved or that has another shape, including but not limited to being concave with respect to the multi-channel optical path, with respect to the single-channel optical path, or both. A concave diffraction grating may function both to diffract and to image the light signals. Thus embodiments of the invention that comprise a concave diffraction grating may not require imaging components, or the imaging components used with such gratings may be simpler than those used with planar diffraction gratings.

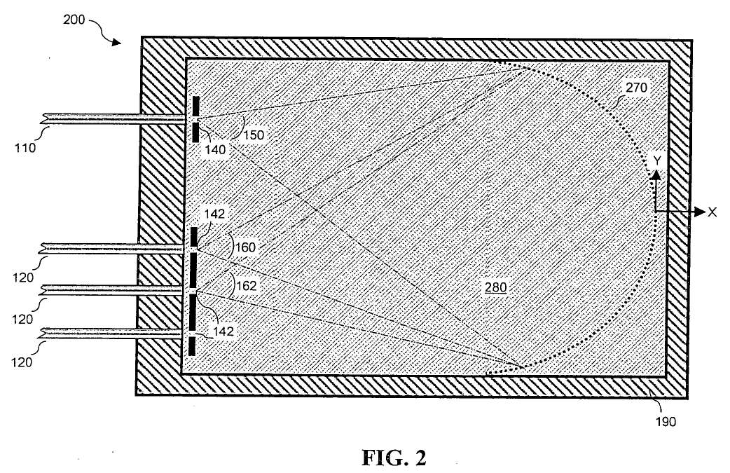

FIG. 2 is a functional diagram of example optical multiplexer/de-multiplexer 200, according to an embodiment of the invention in which a diffraction grating is used that is concave and reflective. In device 200, apertures 140 and 142 and diffraction grating 270 comprise regions within substrate 280 that have an altered refractive index. These regions may be formed by processes that include, but are not limited to, those described with respect to FIGS. 4A, 4B, or 5A below.

Diffraction grating 270 comprises diffraction lines, each of which is parallel to the Z axis. These diffraction lines are positioned along a curve in the X-Y plane that is concave with respect to both the multi-channel optical path and the single-channel optical paths. Concave reflection grating 270 advantageously performs the imaging, focusing or collimating functions without requiring imaging optical devices.

Diffraction grating 270 reflects the light signals that are incident on it. Accordingly, the optical components both of the multi-channel optical path and of the single-channel optical paths are located at positions with negative X coordinates.

Except as described above, optical multiplexer/de-multiplexer 200 and its components are similar in form, manufacture, function and design alternatives to the corresponding components of device 100.

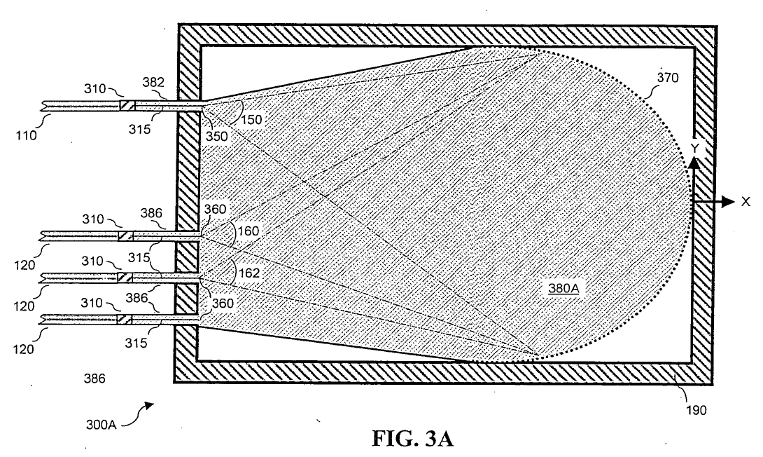

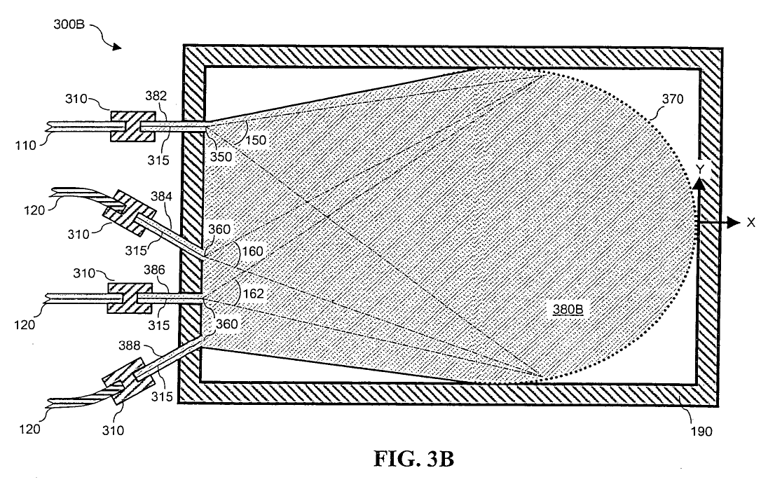

FIGS. 3A and 3B are functional diagrams of example optical multiplexer/de-multiplexers 300A and 300B, according to two embodiments of the invention. Device 300A is formed both by shaping substrate 380A and by altering the refractive index of regions within substrate 380A. Similarly, device 300B is formed both by shaping substrate 380B and by altering the refractive index of regions within substrate 380B. Each device 300A or 300B has one grooved and convex surface, which is on the maximum X side of substrate 380A or 380B.

The convex surface of substrate 380A and 300B and the grooves on this surface constitute reflective diffraction grating 370. Diffraction grating 370 is concave with respect to the paths of the light signals used, such as 150, 160 and 162. The grooves function in a manner similar to the diffraction lines of diffraction grating 270. Concave diffraction grating 370 advantageously performs both the diffraction function and the imaging function without requiring separate imaging optical devices.

In device 300A, the minimum X surface of substrate 380A includes protrusions 382 and three instances of protrusion 396. Each of these protrusions extends from substrate 380A in the negative X direction and each is parallel to the X axis. Protrusion 382 is the multi-channel protrusion and carries multi-channel light signal 150. Protrusions 386 are the single channel protrusions and each carries a corresponding single-channel light signal, such as 160 or 162.

In device 300B, the minimum X surface of substrate 380B includes multi-channel protrusion 382, and single-channel protrusions 384, 386 and 388. Protrusion 382 is parallel to the X axis and conveys multi-channel light signal 150. Protrusion 384 is angled to extend in the positive Y/negative X direction and conveys single-channel light signal 160. Protrusion 386 is parallel to the X axis and conveys single-channel light signal 162. Protrusion 388 is angled to extend in the negative Y/negative X direction and carries another instance of a single-channel light signal.

In both devices 300A and 300B, each protrusion 382, 384, 386 or 388 includes a corresponding optical path 315. Each protrusion and its corresponding optical path are coupled by optical couplers 310, either to multi-channel external optical path 110 or to a corresponding instance of single-channel external optical paths 120.

Each optical guide 315 includes one or more regions of altered refractive index within substrate 380A or 380B. Such regions may be formed by techniques that include, but are not limited to, those discussed with respect to FIGS. 4A, 4B, 5A or 6 below.

Each optical guide 315 starts at the end of its corresponding protrusion. Each optical guide 315 extends at least substantially through the X-dimension length of its corresponding protrusion and may extend beyond that protrusion in the positive X direction. Each optical guide 315 ends at the point of the diffraction plane of diffraction grating 370 that corresponds to the light signal conveyed by that particular optical guide. Specifically, the instance of optical guide 315 within protrusion 382 ends at multi-channel point 350, and conveys multi-channel light signal 150 to or from multi-channel point 350. The instances of optical guides 315 within protrusions 384, 386 or 388 end at a corresponding single-channel point 360 and convey a corresponding single-channel light signal, such as 160 or 162, to that corresponding single-channel point 360.

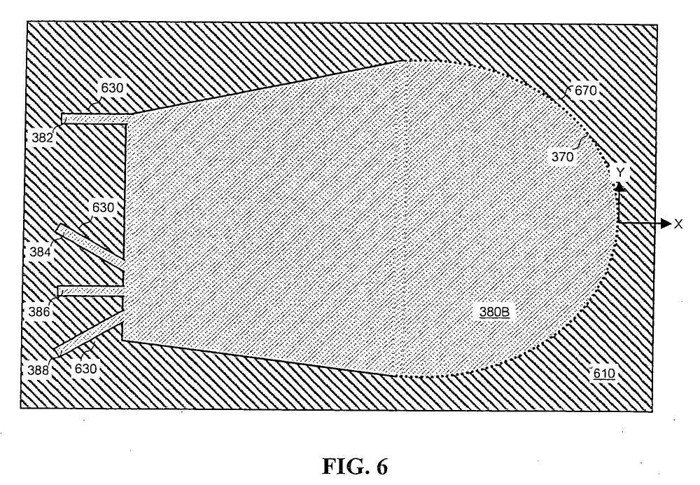

Any or all of protrusions 382, 384, 386 and 388, the convex surface of substrate 380A or 380B and the grooves of diffraction grating 370 may be formed by an injection molding process similar to that discussed below with respect to FIG. 6. Alternatively, any or all of these features may be formed by a process that includes, but is not limited to: removing portions of a surface of a substrate to form grooves therein; drawing a diamond-tipped scribe along a surface of a substrate to form grooves therein; removing portions of a substrate to form protrusions; adding protruding substrate pieces to a base substrate piece; or combinations thereof.

In various embodiments of the invention, the optical couplers used may be any components or devices that physically couple, optically couple or both physically and optically couple the optical multiplexer/de-multiplexer with the multi-channel external optical path used, or with one of the single-channel external optical paths used. Alternatively or additionally, housing 190 may aid in this coupling.

In various embodiments of the invention, the optical guides used may be any optical component or components that conveys a light signal between the external optical path used and the point of the diffraction plane that corresponds to that light signal. The optical guides used may also perform the aperture function. The optical guides may be, but need not be, optical waveguides.

In some embodiments of the invention, the optical guides include a central region having a relatively high refractive index and a region that surrounds the central region and that has a relatively low refractive index. Light injected into the central region is conveyed and directed by the optical guide, because the light tends to stay in the central region by means of being internally refracted at the boundary between the central region and the surrounding region.

The central region of such an optical guide may form a cylinder, the surrounding region may from a hollow cylinder, or both. The cross section of these cylinders may be round, square, rectangular, planar (that is, a rectangular shape with one dimension substantially larger than the other), or may have another shape. The length of the cylinder may be straight, angled, curved, have another shape, or be a combination of shapes, or may have another shape. In some embodiments of the invention, such regions are formed as discussed below with respect to FIGS. 4A, 4B or 6.

In various embodiments of the invention, the functions of the optical couplers and of the optical guides used may include, but are not limited to: collimating; dispersing; focusing; correcting for refraction at the boundary between the optical path and the substrate; altering the wave front curvature of the light signal that is conveyed; directing the light signal to or from the external optical path; directing the light signal to or from the point of the diffraction plane that corresponds to that light signal; other functions; or combinations thereof. In various embodiments, these functions may be performed by the optical guides used, by the optical couplers used, or may not be performed by either of these components. In some embodiments, the function of the optical couplers, of the optical guides or both may depend on whether the light signal is being conveyed toward the external optical path, or toward the corresponding multi-channel or single-channel point of the diffraction plane.

FIG. 3B shows an embodiment of the invention that uses angled protrusions to match the pitch of the paths of the single channel light signals. Substrate 380B includes multi-channel protrusion 382 and single-channel protrusions 384, 386 and 388. Protrusion 384 has the highest Y position of the single-channel protrusions and is angled upward in the Y dimension. Straight, single-channel protrusion 386 is the next highest protrusion. Protrusion 388 is the single-channel protrusion that has the lowest position and is angled downward in the Y dimension.

Thus, the outer ends of the three single-channel protrusions are positioned with enough separation between them to attach an optical fiber to the end of each protrusion. Embodiments of the invention such as the one of FIG. 3B advantageously eliminate the need for other devices or processes to match the pitch of the paths of the single channel light signals as they enter and exit the optical multiplexer/de-multiplexer.

In some embodiments of the invention, optical fibers that convey the single-channel light signals are coupled to the outer ends of the single-channel protrusions. Due to the diameter of the optical fibers, plus the size of the optical couplers used, plus the need to leave a workable gap between adjacent fibers or couplers, the minimum practicable distance between centers of adjacent optical fibers may be, for example, about 125 micrometers (μm). However, the pitch between the single-channel points of the diffraction plane may be narrower, for example, about 40 μm.

In the embodiment shown, each protrusion 382, 384, 386 or 388 ends with a surface that is normal to the direction of travel of the light. This may help optimize the efficiency with which the light is transferred between the optical multiplexer/de-multiplexer and the optical fibers attached thereto. Nevertheless, other end surfaces, shapes or angles may be used.

The pitch matching shown in the embodiment of the invention of FIG. 3B uses protrusions and optical guides with a rectangular shape formed from straight lines. In other embodiments, the protrusions and optical guides may be curved in the X-Y plane, may be shaped like an “S” curve, or may be curved or angled in the Z dimension.

However other embodiments of the invention, for example, the embodiment of FIG. 3A, exclusively use straight protrusions. In some of those embodiments, a device external to the optical multiplexer/de-multiplexer may be used to translate the pitch of the light signals at the surface of the multiplexer/de-multiplexer to the pitch of the optical fibers. Alternatively, a process may be applied to the ends of the optical fibers that narrows these ends, perhaps by removing cladding around the core of the optical fiber. Alternatively, the pitch of the optical fibers that attach to the optical multiplexer/de-multiplexer may align with the pitch of the diffraction points of the single-channel light signals, and thus no pitch matching is required.

Even though FIGS. 1, 2, 3A and 3B are drawn as cross sectional side views, each should be interpreted as a functional diagram. These figures are not drawn to scale, nor do they maintain an accurate aspect ratio. The shapes of the optical components shown are only examples of possible shapes for those components. The lines used to denote light signals 150, 160 and 162 are merely suggestive of the general region of the device in which these light signals travel, and are not intended to represent contours of equal illumination intensity, the maximum extent of the light signals or the properties of the optical imaging devices used. Further, the optical components shown in the optical multiplexer/de-multiplexers may be altered, rearranged or omitted, or other optical components may be added.

FIGS. 4A and 4B respectively show a top view and a side view that illustrate a process of manufacturing substrate 280 that may be used in some embodiments of the invention, for example, the embodiment of FIG. 2. In this process, regions within substrate 280 are exposed to light from one or more light sources 410. These regions constitute optical imaging components 140 and 142 and the diffraction lines of diffraction grating 270. The locations and the shapes of these regions are patterned by mask 420.

This process of exposure to light creates each instance of apertures 140 and 142 by changing the optical properties of one or more regions within substrate 280. Similarly, this process creates diffraction grating 270 by exposing substrate 280 to create closely and uniformly spaced diffraction lines (which are actually cylinders, as discussed above) as substrate regions with altered refractive index.

Light source 410 may be any device or apparatus that emits light of a suitable wavelength and dispersion pattern to expose suitable regions within substrate 280. Light source 410 may be a laser, an assembly that includes a bulb and reflector, or another light source.

In the embodiment of the invention shown in FIGS. 4A and 4B, mask 420 is held in alignment with substrate 280 during the exposure process. Mask 420 provides the patterning of the altered regions desired, that is, mask 420 controls the position and shape of each region. Mask 420 may be suitable for use with a light source that emits a broad flood of light, as well as for use with a narrow light beam such as may be produced by a laser.

In various embodiments of the invention, the path of light from the light source to the substrate may pass through lenses, mirrors or other optical devices. These devices may be fixed in their optical properties, they may have adjustable optical properties that can be used to control how and where the light reaches the substrate, or they may be a combination of fixed and adjustable devices.

During the process of exposing the substrate, the relative positions of the light source and the substrate may be altered to form the desired regions. Alternatively or additionally, adjustable mirrors or lens assemblies may be used to pattern the exposure of the desired regions.

In some embodiments of the invention, a programmed sequence of exposures controls the patterning of the regions to be altered. Each programmed exposure may comprise any or all of the following steps: positioning the light source; positioning the substrate; adjusting any optical devices within the optical path; setting the intensity of the light source; turning on the light source; altering positions, settings or adjustments while the light source is on; or turning off the light source. Such a program may also control the duration of each exposure, the intervals between altering the exposure conditions or the rate at which the exposure conditions are altered.

Other embodiments of the invention may control the patterning that forms the regions by using various combinations of the above processes or other processes. Embodiments that employ a programmed sequence of exposures may or may not also employ a mask.

Some embodiments of the invention may produce boundaries of altered regions that have an abrupt transition between unaltered substrate material that has a base refractive index and completely altered substrate material that has a maximally different refractive index. Other embodiment may produce a gradual increase in the amount of alteration in the refractive index across the boundary of a region.

Yet other embodiments may allow the patterning of the regions to control which regions are fully subjected to the altering process and which regions are only partially subjected. Thus, regions may be formed with varying amounts of alteration in the refractive index of the region. The controlled variation may be continuous, such as may be produced by a programmed sequence of exposures that vary in duration. Alternatively, the controlled variation may occur in steps, such as may be produced by a mask that contains only clear regions of 100% transmission, light gray regions of 67% transmission, dark gray regions of 33% transmission and black regions that do not transmit the light used to expose the substrate.

In some embodiments of the invention, the altering process increases the refractive index of the regions that are subjected to the process. In other embodiments, the process decreases the refractive index. The patterning of the regions to be exposed to the process generally depends on the direction of the alteration in the refractive index.

For example, suppose that an optical guide is to be formed by subjecting a substrate to the process. In this case, an optical device is desired with a central region having a higher refractive index than the surrounding region. The central region becomes the light carrying portion of the optical guide. If the process used increases the refractive index of the substrate, then the central portion of the optical guide should be subjected to the process to form the central, light carrying region with a higher refractive index. Thus, the region subjected to the process may be, for example, a solid cylinder having the diameter desired for the light carrying region. Alternatively if the process decreases the refractive index, then all regions surrounding a central region of the optical guide should be subjected to the process, and the unaltered central region carries the light within the optical guide. Thus, the region subjected to the process may be, for example, a hollow cylinder with the diameter of the unaltered hollow being the diameter desired for the light carrying region.

In some embodiments of the invention, the paths of the multi-channel light signal used and of the single-channel light signals used are confined in the Z direction. Such embodiments may advantageously reduce the overall size of the optical multiplexer/de-multiplexer.

Such embodiments may also advantageously reduce the distance through the substrate through which the light or other exposure process must precisely penetrate. For example, when a light beam that travels through the substrate in the Z direction is used to alter the refractive index of the substrate, dispersion of the beam within the substrate may create exposed regions that widen in the X direction, the Y direction or both as the region extends away from the light source in the Z direction. Under these conditions, narrowing the Z width of the substrate advantageously reduces this widening effect.

In other embodiments of the invention, the light signals used pass through a layer of the substrate that has a narrow width in the Z direction. In some of these embodiments, two outer layers of substrate surround a central layer of substrate, and the refractive index of the central layer is higher than the refractive index of each outer layer, thus confining the light beams used to the central layer.

In yet other embodiments of the invention, a relatively thin layer of substrate is attached to and mechanically supported by a relatively thick layer of substrate. The light signals pass through and are confined to the thin layer because the refractive index of the thin layer is higher than that of the thick layer and higher than that of the free space or other material on the side of the thin layer that is opposite to the thick layer.

In various embodiments of the invention, such substrate layers may be formed by processes that include, but are not limited to: casting a layered substrate in a mold filled with layers of different materials with different refractive indices; laminating materials with different refractive indices to form a layered substrate; coating a thick layer of substrate with a thin layer of substrate; or exposing a central layer within a substrate to a process that increases the refractive index of the central layer. Casting, laminating and coating of optical materials are known in the art.

In other embodiments of the invention, the process to which regions of the substrate are exposed to alter the refractive index is such that the regions do not significantly widen as the process extends through the substrate. Such processes may include but are not limited to exposing the substrate to high-energy electromagnetic radiation, exposing the substrate to X-rays, or exposing the substrate to a collimated X-ray beam. A synchrotron, among other devices, may be used to produce a suitable collimated X-ray beam.

In some embodiments of the invention, the optical exposing process forms at least two optical devices within single substrate, with the devices being advantageously formed in permanent alignment with each other by virtue of the exposing process. Such one step formation and alignment provides significant cost and complexity savings over manufacturing techniques that assemble discrete optical components and then align them, or that require mechanical components to hold the optical components in alignment.

Holographic techniques may be used in the exposing process that makes various optical components within various embodiments of the invention. Holographic techniques may be used to form optical components within an optical multiplexer/de-multiplexer according to various embodiments of the invention. Such components include, but are not limited to, diffraction gratings.

FIG. 5A illustrates one process by which standard holographic components may be used to make a diffraction grating. A beam from laser 510 is expanded by beam expander 520 and then spatially filtered by spatial filter 530. The resulting laser beam is split into two beams by beam splitter 540. Each laser beam is then reflected and imaged by a corresponding curved mirror 550 that is concave with respect to the laser beam. Then each laser beam passes through a corresponding spatial filter 560. The two beams then recombine and interfere with each other, according to the well known principles of light wave interference and holography. A concave surface of substrate 580 records the resulting interference pattern in the form of regions within substrate 580 that have an altered refractive index.

Concave diffraction grating 570 includes the regions within substrate 580 with altered refractive index. Each such region becomes one of the diffraction lines of grating 570. The diffraction lines of grating 570 may be curved in the Y-Z plane, not uniform in spacing, not uniform in size, not parallel with each other, or a combination thereof. When properly designed, diffraction grating 570 advantageously corrects for the aberration present in many diffraction gratings.

Various holographic configurations may be used to generate an interference pattern suitable for exposing a diffraction grating or other optical component used in some embodiments of the invention. In some of those configurations, beam expander 520 may include, but is not limited to, a lens, an assembly of lenses or other optical devices to expand the laser beam. In others of those configurations, the beam splitter used may include, but is not limited to, a partially reflective mirror to split the laser beam, or one or more mirrors to alter the direction of either or both of the split beams. In yet others of those configurations, one or both of the concave mirrors used may be replaced with a planar mirror and a lens, an assembly of lenses or other imaging devices.

The spatial filters used to generate an interference pattern suitable for exposing an optical component used in some embodiments of the invention may be, but need not be, simple pin holes through an opaque surface or volume. To make other embodiments, no spatial filters are used in forming the diffraction grating, though using spatial filters may advantageously decrease the aberration of the diffraction grating that is formed.

If a planar diffraction grating has only diffraction lines that are straight and parallel to each other, then typically an image that is optimal is formed for only one of the single-channel light signals. The other single-channel light signals suffer from some degree of aberration, which may result in transferring that signal through the optical multiplexer/de-multiplexer at a lower efficiency. Aberration may also result in distortion of a light signal because of a change in the effective bandwidth of the multiplexer/de-multiplexer for signals at that wavelength.

An aberration correcting diffraction grating may be made using holographic techniques, among other techniques. An aberration correcting diffraction grating may be planar, concave or have another shape, though typically correcting for aberration is more important when a non-planar diffraction grating is used.

In some embodiments of the invention, a housing secures substrate 580 in alignment with the other optical devices of the optical multiplexer/de-multiplexer, and light signals travel to and from diffraction grating 570 via open space or another suitable medium.

Other embodiments of the invention use a substrate that is fabricated from more than one piece of optical material. The pieces within a substrate may comprise different materials, including but not limited to, materials with an approximately equal base refractive index but that differ in how much, if any, their refractive index is altered by the alteration process used.

FIG. 5B illustrates fabricating a substrate from more than one substrate piece. In this embodiment of the invention, diffraction grating 570 is formed on a concave surface of substrate piece 580, which is then mated with and secured to substrate piece 585. Substrate piece 585 has a convex surface that aligns with the concave surface of substrate 580. These concave and convex surfaces may have corresponding notches and protrusions, or other features that aid in properly positioning and aligning the two substrate pieces. When aligned and secured together, substrate pieces 580 and 585 constitute a concave diffraction grating within a substrate. The grating and substrate of FIG. 5B are similar to diffraction grating 270 within single-piece substrate 280, as shown in FIGS. 2, 4A and 4B.

In various embodiments of the invention, substrate pieces 580 and 585 may be formed from the same optical material or from different materials. If substrate piece 580 is photosensitive and substrate piece 585 is not, then a process similar to that shown in FIG. 5A may be used to form a diffraction grating in a substrate shaped like substrate 280, but that is photosensitive only within the portion of the substrate that comprises piece 585. Using such a partially photosensitive substrate allows the manufacturing steps shown in FIG. 5A and FIG. 5B to be performed in either order, that is, to assemble the two substrate pieces first and then expose the substrate or to expose one substrate piece first and then assemble the substrate. This choice may depend on which is more cost effective or which produces a higher quality optical multiplexer/de-multiplexer.

However, a usable diffraction grating would probably not be formed by applying the holographic technique of FIG. 5A to expose a substrate shaped like substrate 280 that is photosensitive within its entire volume. This is because too many regions having altered refractive index would be formed under these conditions.

Optical multiplexer/de-multiplexer 300A or 300B, shown in FIG. 3A or 3B, may also include a substrate fabricated from more than one piece of optical material. In some embodiments, optical multiplexer/de-multiplexer 300A or 300B includes a first substrate piece that is photosensitive and a second substrate piece that is not. The first substrate piece extends from the ends of protrusions 382, 385 or 387 to the plane that contains multi-channel point 350 and single-channel points 360. The second substrate piece extends from these points to the Y axis. As with substrate pieces 580 and 585, the first and second substrate pieces may have corresponding notches and protrusions, or other features that aid in properly positioning and aligning them.

Using a substrate that is only partially photosensitive, optical guides 315 may be formed by a directing a laser beam into the ends of protrusions 385, using a process that may be similar to that shown in FIGS. 4A and 4B except that the beam is directed into the substrate from the minimum X end of the substrate. Such an exposure does not alter the refractive index of the substrate within the portion of the substrate that comprises the second substrate piece, thus the optical guides formed by the exposure end at the boundary between the substrate pieces.

Not all embodiments of the invention use exposure to light as the process that alters the refractive index of substrate regions. The substrate may be subjected to any process that alters the refractive index within regions of the substrate. In various embodiments of the invention, the process may include: exposure to an electron beam; exposure to electromagnetic radiation; exposure to light; exposure to a laser beam; exposure to a holographic pattern; exposure to X-rays; exposure to collimated X-rays; exposure to collimated X-rays from a synchrotron; exposure to a chemical process; exposure to heat; exposure to pressure; a sequence of processes; a combination of processes applied concurrently; or another appropriate process.

In various embodiments of the invention, the alteration of regions within the substrate that produces the altered refractive index may include, but need not be limited to: an altered physical structure; an altered chemical composition; an altered molecular structure; or a combination thereof.

FIG. 6 shows a cross-sectional side view illustrating the fabrication of a substrate used in some embodiments of the invention. Substrate 380B, as shown in FIG. 3B, is shaped using an injection molding process. Injection mold 610 includes grooved concave surface 670 and, on an opposite surface, includes a number of hollow cylinders 630 that intrude into mold 610. Grooved concave surface 670 forms concave diffraction grating 370 by molding the grooved and convex surface of substrate 380. Cylinders 685 mold substrate 380B to form protrusions 382, 384, 386 and 388.

In an injection molding process according to some embodiments of the invention, a precursor to an optical material is injected into a mold, such as 610. During this injection step, the optical material precursor has a pliable form, including but not limited to a gel, a liquid, a solution, a slurry or a mixture. Then the optical material precursor is solidified, and a solid piece of the resulting optical material is removed from the mold. In various embodiments of the invention, heat, pressure, solvents or a combination thereof may be used to make the optical material precursor temporarily pliable or to permanently set the optical material.

Solgel is an example of an optical material precursor that is suitable for injection molding. A solgel-like optical material is a gel based on particles of a silica-like material. Using solgel in a molding process to form optical devices is known. One skilled in the art will appreciate that a variety of optical materials, including but not limited to solgel-like optical materials, may be used in conjunction with a molding process to form substrates suitable for use in various embodiments of the invention.

The optical material used in some embodiments of the invention is photosensitive, while other embodiments use materials sensitive other processes that alter the refractive index of the material. A variety of alterable optical materials may be formed by, among other possible materials, a glass type material that is loaded with hydrogen. After light of a first wavelength (ultraviolet, among other possible wavelengths), has passed through a region of such material, then the physical structure of that region is altered. This change in physical structure alters the refractive index at other wavelengths within the region (infrared, among other possible wavelengths).

In other embodiments of the invention, materials are used that are subject to alterations in the chemical structure or in the molecular structure of regions within the material, where the alterations result in the altered region having a refractive index that is higher or lower than the base refractive index of unaltered regions of the material.

In various embodiments of the invention, the alterable optical material used to form an integral piece of optical material may include: a photosensitive material; a material susceptible to chemical alteration; a doped material; a heat sensitive material; a pressure sensitive material; a glass type material; a glass type material that is loaded with hydrogen; a solgel type of material; a solgel type of material that is loaded with hydrogen; a combination thereof; or another appropriate material.

Some embodiments of the invention comprise a substrate that is not homogeneous in its response to the process that alters the refractive index of regions within the substrate. For example, some embodiments of optical multiplexer/de-multiplexer 3001B, as shown in FIG. 3B, are formed by casting, that is, by putting two or more different optical materials with different refractive indices into injection mold 610.

Injection mold 610 may be partially filled with a first type of material that is photosensitive and a second type of material that is not. A pressure or force, including but not limited to gravity, then holds the photosensitive material so that it extends from the ends of protrusions 382, 384, 386 and 388 to the plane of multi-channel point 350 and single-channel points 360. Then, the remainder of injection mold 610 may be filled with a material that is compatible with the first material but is not photosensitive.

Or visa versa, injection mold 610 may first be partially filled with a non-photosensitive material from the Y-Z plane to the plane of points 350 and 360. Then, the remainder of injection mold 610 may be filled with a photosensitive material.

Using such a non-homogeneous substrate, optical guides 315 may be formed by a directing a laser beam into the ends of protrusions 385, using a process that may be similar to that shown in FIGS. 4A and 4B. The maximum-X ends of optical guides 315 are formed by the boundary between the portions of the substrate that are formed from different materials, because the refractive index of only part of the substrate is altered by the laser beam.

In various embodiments of the invention, the various optical components within an optical multiplexer/de-multiplexer are formed by various injection molding processes. In other embodiments, chemical, mechanical, exposure or other processes of shaping a substrate by removing material from the substrate or depositing material to the substrate or both are employed to form optical components.

Such processes include but are not limited to the known LIGA process and variations thereon. LIGA is a micromachining technology, with an acronym that comes from German terms for lithography, electroplating, and molding. In one embodiment that uses a LIGA-like process, the shape of the injection mold used to shape the substrate used is patterned by applying a resist, including but limited to polymethylmethacrylate (PMMA), to the substrate, then exposing the resist to collimated X-rays such as from a synchrotron, then developing the resist to dissolve and remove those regions of the resist in which molecular bonds were broken by the X-rays (which increases the soluability of those resist molecules), and then electroplating a metallic surface on the shaped resist. In yet other embodiments, a LIGA-like process is used to individually form each substrate.

In yet other embodiments of the invention, such as devices 100 or 200 shown in FIGS. 1 and 2, a substrate is used to form optical devices from altered regions of the substrate, but the shape of the substrate does not form an optical device.

Multiple optical components of the optical multiplexer/de-multiplexer may be are formed by injection molding, or by other techniques that shape multiple optical components within a substrate. Such optical components are advantageously formed in permanent alignment with each other by virtue of the alignment of the features within the injection mold, or other shaping processes. Such one step formation and alignment provides significant cost and complexity savings over manufacturing techniques that assemble discrete optical components and then align them, or that require mechanical components to hold the optical components in alignment.

The foregoing drawing figures and descriptions are not intended to be exhaustive or to limit the invention to the forms disclosed. Rather, they are presented for purposes of illustrating, teaching and aiding in the comprehension of the invention. The invention may be practiced without the specific details described herein. Numerous selections among alternatives, changes in form, and improvements can be made without departing from the invention. The invention can be modified or varied in light of the teachings herein, the techniques known to those skilled in the art, and advances in the art yet to be made. The scope of the invention is set forth by the following claims and their legal equivalents.

What is claimed is:

1. A method of making an optical multiplexer/de-multiplexer, the method comprising:
fabricating a substrate from a material having a refractive index that can be altered by a process;
subjecting a region within the substrate to the process; and
altering, by the subjecting, the refractive index within the region to form an optical component of the multiplexer/de-multiplexer.

2. The method of claim 1, wherein the process is selected from a group consisting of: exposing the region to an electron beam; exposing the region to electromagnetic radiation; exposing the region to light; exposing the region to a laser beam; exposing the region to a light wave interference pattern; exposing the region to X-rays; exposing the region to a collimated X-ray beam; subjecting the region to a chemical process; subjecting the region to heat; subjecting the region to pressure; and a combination thereof.

3. The method of claim 1, wherein the altering is selected from a group consisting of: altering a physical structure of the substrate within the region; altering a chemical composition of the substrate within the region; and altering a molecular structure of the substrate within the region.

4. The method of claim 1, wherein the optical component formed by the altering is selected from a group consisting of: a diffraction grating; a planar diffraction grating; a concave diffraction grating; an aberration correcting diffraction grating; an optical component for a multi-channel optical path; an optical component for a single-channel optical path; an optical coupler; an optical guide; an optical aperture; and an optical imaging component.

5. The method of claim 1, wherein the subjecting and the altering of the substrate form at least two optical components of the multiplexer/de-multiplexer, wherein the at least two components are formed in alignment with each other within the substrate.

6. The method of claim 1, wherein the fabricating of the substrate comprises shaping the substrate, and at least one optical component of the multiplexer/de-multiplexer is formed by the shaping.

7. The method of claim 6, wherein the shaping includes shaping of the substrate by injection molding.

8. The method of claim 1, wherein the fabricating of the substrate comprises attaching a first piece of the substrate comprising the material having an alterable refractive index to a second piece of the substrate.

9. The method of claim 1, wherein the fabricating of the substrate comprises forming a substrate that is not uniformly susceptible to the process that alters the refractive index.

10. The method of claim 1, wherein the subjecting comprises patterning the region by at least one of exposing the region through a mask, and using a programmed sequence of exposures.

11. The method of claim 1, wherein the material having the alterable refractive index is selected from a group consisting of: a photosensitive material; a material susceptible to chemical alteration; a doped material; a heat sensitive material; a pressure sensitive material; a glass type material; a glass type material that is loaded with hydrogen; a solgel type material; and a combination thereof.

12. A device to multiplex/de-multiplex light signals, the device comprising:
optical components configured to multiplex light signals when operated as a multiplexer and to de-multiplex light signals when operated as a de-multiplexer; and
a substrate that comprises a material having a base refractive index and that includes a region with a refractive index that differs from the base refractive index;
wherein one of the optical components comprises the region with the different refractive index.

13. The device of claim 12, wherein the region with the different refractive index is selected from a group consisting of: a region with an altered physical structure; a region with an altered chemical composition; and a region with an altered molecular structure.

14. The device of claim 12, wherein the optical component that comprises the region with the different refractive index is selected from a group consisting of: a diffraction grating; a planar diffraction grating; a concave diffraction grating; an aberration correcting diffraction grating; an optical component for a multi-channel optical path; an optical component for a single-channel optical path; an optical coupler; an optical guide; an optical aperture; and an optical imaging component.

15. The device of claim 12, wherein the substrate comprises at least two of the optical components and the substrate holds the at least two components in alignment with each other.

16. The device of claim 12, wherein a shape of the substrate forms at least one of the optical components.

17. The device of claim 12, and further comprising at least two substrates.

18. The device of claim 12, wherein at least a portion of the substrate comprises a material selected from a group consisting of: a photosensitive material; a material susceptible to chemical alteration; a doped material; a heat sensitive material; a pressure sensitive material; a glass type material; a glass type material that is loaded with hydrogen; a solgel type material; and a combination thereof.

19. A device for optical multiplexing/de-multiplexing, the device comprising:
a plurality of optical component means, the plurality constituting means for combining single-channel light signals into a multi-channel light signal when operated as a multiplexer, and the plurality constituting means for separating the multi-channel light signal into the single-channel light signals when operated as a de-multiplexer; and
a substrate means for forming at least one of the optical component means, wherein the substrate means has a base refractive index and includes a region having an refractive index that is different from the base refractive index and the at least one optical component means comprises the region with the different refractive index.

20. The device of claim 19, wherein the region with the different refractive index is selected from a group consisting of: a region with an altered physical structure; a region with an altered chemical composition; and a region with an altered molecular structure.

21. The device of claim 19, wherein the at least one optical component means is selected from a group consisting of: a diffraction means; a diffraction means that is also a means for imaging; a diffraction means that is also a means for correcting aberration; a means for optically coupling the multi-channel light signal with the device; a means for optically coupling one of the single-channel light signals with the device; a means for optically guiding the multi-channel light signal; a means for optically guiding one of the single-channel light signals; an aperture means for spatially filtering the multi-channel light signal; an aperture means for spatially filtering one of the single-channel light signals; a means for imaging the multi-channel light signal; and a means for imaging one of the single-channel light signals.

22. The device of claim 19, wherein the substrate means is further a means for forming a second one of the optical component means and wherein the substrate means holds the at least one optical component means and the second optical component means in alignment with each other.

23. The device of claim 19, wherein the substrate means is further a means for forming a second one of the optical component means, the second optical component means being formed by a shape of the substrate means.

24. The device of claim 19, and further comprising a second substrate means.

25. The device of claim 19, wherein at least a portion of the substrate means comprises a material selected from a group consisting of: a photosensitive material; a material susceptible to chemical alteration; a doped material; a heat sensitive material; a pressure sensitive material; a glass type material; a glass type material that is loaded with hydrogen; a solgel type material; and a combination thereof.
